(19) United States
(12) Patent Application Publication
(10) Pub. No.: US 2014/0092798 A1
(43) Pub. Date: Apr. 3, 2014

(54) METHODS PERFORMED BY MOBILE COMMUNICATION DEVICES

(71) Applicant: MEDIATEK INC., Hsin-Chu (TW)

(72) Inventors: Wei-Jen Chen, Taipei City (TW); Lun-Han Chang, Taoyuan County (TW); Sung-Chiao Li, Taoyuan County (TW); Wei-Nan Sun, Hsinchu County (TW)

(73) Assignee: MEDIATEK INC., Hsin-Chu (TW)

(21) Appl. No.: 13/632,113

(22) Filed: Sep. 30, 2012

(51) Int. Cl. H04W 52/02

(52) U.S. Cl. 370/311

(57) ABSTRACT

An embodiment of the invention provides a method performed by a mobile communication device in a discontinuous reception (DRX) mode. First, the device dumps contemporarily received data and performs multipath search while a beginning part of a relevant sub-frame in a control channel is being transmitted. Next, the device dumps contemporarily received data and decodes dumped data with an accelerated rake while a middle part of the relevant sub-frame is being transmitted. Then, the device decodes contemporarily received data with a normal rake while an ending part of the relevant sub-frame is being transmitted.

### BACKGROUND

1. Technical Field

The invention relates generally to mobile communications, and more particularly, to methods performed by mobile communication devices.

2. Related Art

Some mobile communication standards allow mobile communication devices, which may be referred to as user equipment or UE, in a mobile communication network to be in a discontinuous reception (DRX) mode. The DRX mode allows a device to be either asleep or awake. Before the device is instructed to keep awake, it may be asleep most of the time and wake up on its own accord intermittently to monitor a control channel to determine whether to receive data on a data channel. For example, the device may need to wake up to receive and decode a data section (e.g. which may be a frame or a sub-frame) in every N data sections on the control channel, wherein N is a positive integer larger than one. If that monitored data section does not instruct the device to keep awake, the device may rest, disregard the following N−1 data sections, and save power by turning off its radio frequency (RF) circuitry when the following N−1 data sections are being transmitted.

It's generally desired that the device operates efficiently and conserves as much power as possible whether or not the device is in the DRX mode.

### SUMMARY

A first embodiment of the invention provides a method performed by a mobile communication device in a DRX mode. First, the device dumps contemporarily received data and performs multipath search while a beginning part of a relevant sub-frame in a control channel is being transmitted. Next, the device dumps contemporarily received data and decodes dumped data with an accelerated rake while a middle part of the relevant sub-frame is being transmitted. Then, the device decodes contemporarily received data with a normal rake while an ending part of the relevant sub-frame is being transmitted.

A second embodiment of the invention provides a method performed by a mobile communication device in a continuous reception mode. First, the device determines whether a beginning part of a sub-frame on a data channel received by a first antenna of the device is sufficient to decode. Next, if the beginning part of the sub-frame received by the first antenna is sufficient to decode, the device measures a second antenna of the device while a remaining part of the sub-frame is being transmitted. Then, the device chooses one from the first and second antennas and uses the chosen antenna to receive at least a beginning part of a next sub-frame on the data channel.

A third embodiment of the invention provides a method performed by a mobile communication device in a continuous reception mode. First, the device enables a first and a second antenna when a beginning part of a sub-frame in a data channel is being transmitted. Then, the device disables an inferior one of the first and second antennas while a remaining part of the sub-frame is being transmitted if a superior one of the first and second antennas is sufficient to receive the remaining part of the sub-frame.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a simplified schematic diagram of data sections transmitted through a control channel and a data channel.

FIG. 2 shows a simplified flowchart of a method performed by a mobile communication device in the DRX mode.

FIG. 3 shows a simplified timing diagram illustrating the device's operations in dealing with a relevant HS-SCCH sub-frame in the DRX mode.

FIG. 4 shows a simplified flowchart of a method performed by a mobile communication device in the DRX mode.

FIG. 5, FIG. 6, and FIG. 7 show three simplified timing diagrams illustrating the device's operations in dealing with a relevant HS-SCCH sub-frame in the DRX mode.

FIG. 8 shows a simplified block diagram of a mobile communication device according to an embodiment of the invention.

FIG. 9 shows a simplified flowchart of a method performed by the device in the continuous reception mode.

FIG. 10 shows a simplified timing diagram illustrating the device's operations in dealing with three pairs of HS-SCCH and HS-DSCH sub-frames in the continuous reception mode.

FIG. 11 shows a simplified block diagram of a mobile communication device according to an embodiment of the invention.

FIG. 12 shows a simplified flowchart of a method performed by the device in the continuous reception mode.

FIG. 13 shows a simplified timing diagram illustrating the device's operations in dealing with three pairs of HS-SCCH and HS-DSCH sub-frames in the continuous reception mode.

### DETAILED DESCRIPTION

Although many different kinds of mobile communication networks may apply the concepts of the invention, for the sake of simplicity, the following detailed description will uses a network that is compatible with Release 7 of the 3rd Generation Partnership Project (3GPP) as an example to explain the embodiments of the invention.

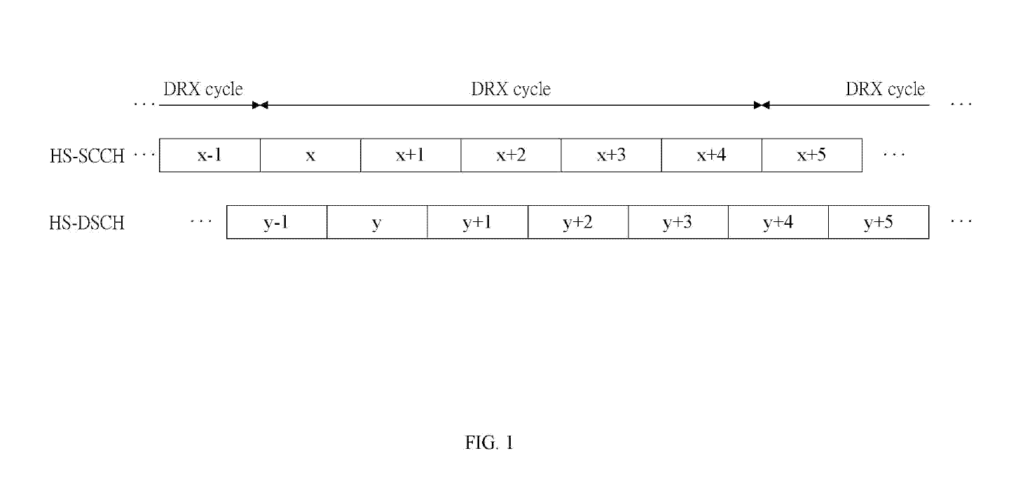

FIG. 1 shows a simplified schematic diagram of data sections transmitted through a control channel and a data channel in an exemplary mobile communication network that is compatible with Release 7 of the 3GPP. The control channel and the data channel are a High Speed Shared Control Channel (HS-SCCH) and a High Speed Downlink Shared Channel (HS-DSCH), respectively. If the mobile communication network is compatible with Release 99 of the 3GPP, the control channel and the data channel may be a Paging Indicator Channel (PICH) and a Secondary-Common Control Physical Channel (S-CCPCH), respectively.

Each of these two channels depicted in FIG. 1 is used to transmit data sections one after another; each of the data sections may also be referred to as a sub-frame. Each HS-DSCH sub-frame is associated with an HS-SCCH sub-frame, the ending part of which overlaps with the beginning part of the associated HS-DSCH sub-frame. For example, HS-DSCH sub-frame y−1 is associated with HS-SCCH sub-frame x−1, HS-DSCH sub-frame y is associated with HS-SCCH sub-frame x, and so on. A mobile communication device in the network may use a rake receiver to decode the HS-SCCH sub-frames and uses an equalizer (EQ) to decode the HS-DSCH sub-frames.

The continuous packet connectivity (CPC) feature of the network allows the device to be in a DRX mode. The DRX mode allows the device to be either asleep or awake. Before the device is passively instructed to keep awake, it may be asleep most of the time and wake up on its own accord intermittently to monitor an HS-SCCH sub-frame every other N HS-SCCH sub-frames. Using FIG. 1 as an example, N is equal to 5 and the device needs to monitor HS-SCCH sub-frames x, x+5, x+10, and so on. The device may disregard HS-SCCH sub-frames x+1˜x+4, x+6˜x+9, and so on, as long as the device is not instructed to keep awake. Before being instructed to keep awake, the device may use a timer to decide when to wake up on its own accord.

If HS-SCCH sub-frame x instructs the device to keep awake, the device will need to receive and decode HS-DSCH sub-frame y. In addition, the device may also need to receive and decode several pairs of HS-SCCH and HS-DSCH sub-frames subsequent to HS-SCCH sub-frame x and HS-DSCH sub-frame y. On the other hand, if HS-SCCH sub-frame x does not instruct the device to keep awake, the device may rest and ignore HS-SCCH sub-frames x+1˜x+4 and HS-DSCH sub-frames y˜y+4. In addition, the device may turn on its RF circuit to receive HS-SCCH sub-frame x only and then turn off its RF circuit when HS-SCCH sub-frames x+1˜x+4 are being transmitted. In other words, the period in which HS-SCCH sub-frames x˜x+4 are transmitted may constitute a DRX cycle; the RF duty of the DRX cycle is 20%. To avoid confusion, for a device that's in the DRX mode and hasn't been instructed to keep awake, the HS-SCCH sub-frames the device needs to receive will be referred to as relevant HS-SCCH sub-frames of the device, while the HS-SCCH sub-frames the device may omit will be referred to as irrelevant HS-SCCH sub-frames of the device.

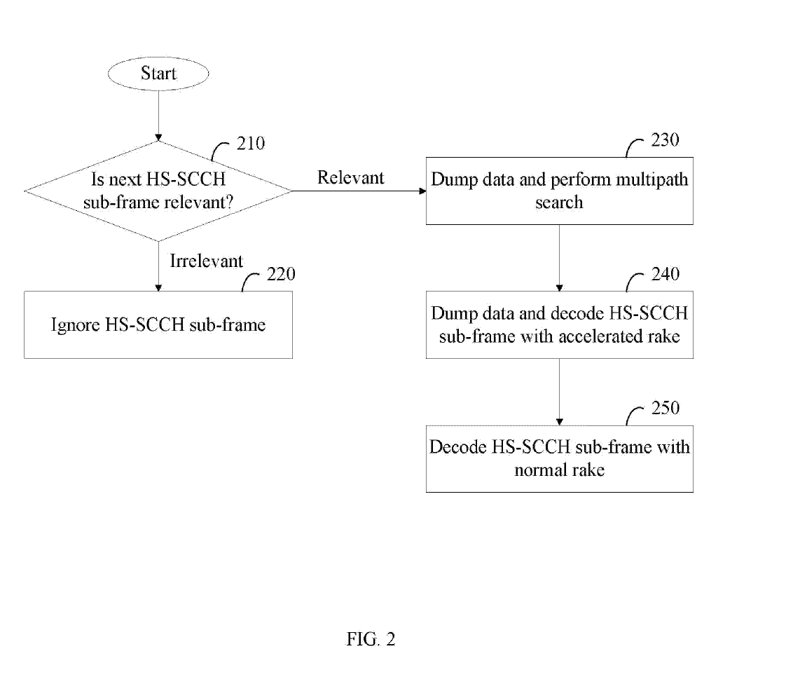

FIG. 2 shows a simplified flowchart of a method performed by a mobile communication device in the DRX mode. At step 210, the device first determines whether the next HS-SCCH sub-frame is a relevant or irrelevant HS-SCCH sub-frame. If it's an irrelevant sub-frame, the device enters step 220; if it's a relevant sub-frame, the device goes to step 230. The device may use a timer to assist its decision-making process at step 210. Using FIG. 1 as an example, if there are five sub-frames in each DRX cycle, HS-SCCH sub-frames x and x+5 may be relevant sub-frames and HS-SCCH sub-frames x−1, x+1, x+2, x+3, and x+4 may be irrelevant sub-frames. In the circumstances, the timer's period may be 5 HS-SCCH sub-frames long.

At step 220, the device keeps asleep and ignores that HS-SCCH sub-frame. Specifically, the device may keep its RF circuit off when that HS-SCCH sub-frame is being transmitted. Moreover, the device may abstain from using that HS-SCCH sub-frame to update the fingers of its rake receiver. This may minimize or eliminate the overhead of RF power consumption caused by finger update.

At step 230, the device wakes up and dumps received data and perform multipath search while a beginning part of the relevant HS-SCCH sub-frame is being transmitted. At this step, the rake receiver may be referred to as a multipath searcher, the correlator engine of which may update the fingers using the dumped data. The dumped data may include information transmitted through several channels, such as the HS-SCCH and HS-DSCH channels, and may be decoded offline later. The dumped data may also be used for other purposes, such as measurement or scrambling code identification.

Because the beginning part of the relevant HS-SCCH sub-frame will not only be dumped for subsequent decode but also be used to update the fingers of the device's rake receiver, the device needs not to use an ending part of a previous HS-SCCH sub-frame, which is an irrelevant one, to perform multipath search. Therefore, the RF circuit of the device needs not to be turned on prematurely to perform multipath search. Without turning on the RF circuit prematurely, unnecessary overhead in RF power consumption may be avoided. The device may leave step 230 after successfully updating the fingers of the rake receiver. With the updated fingers, the device's subsequent operations may become more robust, especially for the moving and birth-death propagation conditions defined in the 3GPP specification. Because step 230 may come to an end when multipath search is completed, the beginning part of the HS-SCCH sub-frame may have a variable length.

At step 240, the device dumps received data and uses the rake receiver to decode the dumped part of the HS-SCCH sub-frame at an accelerated speed while a middle part of the HS-SCCH sub-frame is being transmitted. Step 240 may last until there is no backlog in the decoding process of the HS-SCCH sub-frame; therefore, the middle part of the HS-SCCH sub-frame may have a variable length.

At step 240, the rake receiver may be referred to as an accelerated rake. When performing step 240, the device may activate a single antenna to receive RF signals. This is feasible because it's relatively easier to receive HS-SCCH sub-frames correctly. Because only one antenna is used, the accelerated rake used at step 240 may not need much computing power and may be able to decode the dumped part of the HS-SCCH sub-frame at a relatively high speed.

After the accelerated rack has decoded the previously dumped portion (i.e. the beginning part and the middle part) of the relevant HS-SCCH frame, at step 250, the device uses the rake receiver to decode an ending part of the HS-SCCH sub-frame at a normal speed while that part of the HS-SCCH sub-frame is being transmitted. At this step, the rake receiver may be referred to as a normal rake. Rather than processing previously dumped data, the normal rake at this step processes on-the-fly data. Step 250 may come to an end when the HS-SCCH sub-frame has been decoded completely. As an example, the device may decide whether to reply with an ACK or NACK message at the end of step 250 or shortly afterwards.

Before step 250 comes to an end, the associated HS-DSCH sub-frame may also be on the air, but the device may still be uncertain as to whether it needs to decode that HS-DSCH sub-frame or not. As a result, at steps 240 and 250, the device may need to dump the part of the HS-DSCH sub-frame being transmitted contemporarily. As a result, the device may have a decision delay in decoding the HS-DSCH sub-frame, if it turns out that the device does need to decode the HS-DSCH sub-frame. The length of the decision delay may remain for subsequent HS-DSCH sub-frames if they need to be decoded as well.

After step 250, if the device determines that the HS-SCCH sub-frame does not instruct it to keep awake, the device may rest by turning off its RF circuit after receiving the relevant HS-SCCH sub-frame, and wait for the next relevant HS-SCCH sub-frame to come. On the other hand, if the device determines that the HS-SCCH sub-frame does instruct it to keep awake, the device may keep its RF circuit on to receive subsequent HS-SCCH sub-frames and HS-DSCH sub-frames. The device may use the normal rake to decode the subsequent HS-SCCH sub-frames at no or short decision delay, and use the EQ to decode the subsequent HS-DSCH sub-frames at a relatively longer (e.g. several symbols long) decision delay.

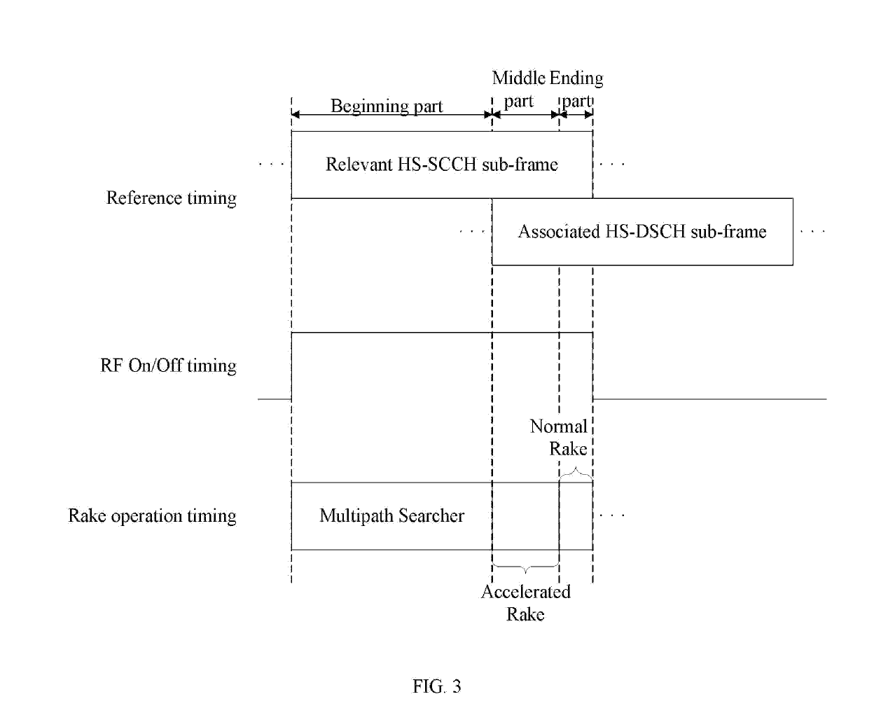

FIG. 3 shows a simplified timing diagram illustrating the device's operations in dealing with a relevant HS-SCCH sub-frame in the DRX mode. In this example, it's assumed that the relevant HS-SCCH sub-frame does not instruct the device to keep awake. If, on the other hand, the relevant HS-SCCH sub-frame does instruct the device to keep awake, the RF circuit will be on to receive subsequent HS-SCCH sub-frames and HS-DSCH sub-frames. As mentioned above, the device may use the normal rake to decode the subsequent HS-SCCH sub-frames at no or short decision delay, and use the EQ to decode the subsequent HS-DSCH sub-frames at a relatively longer (e.g. several symbols long) decision delay.

As FIG. 3 indicates, the RF circuit will be on to receive only the relevant HS-SCCH sub-frame, and will be turned off afterward because the HS-SCCH sub-frame does not instruct the device to keep awake. Furthermore, when the relevant HS-SCCH is being transmitted, the rake receiver first acts as a multipath searcher, then acts as an accelerated rake, and acts as a normal rake in the end. Please note that the three parts of each relevant HS-SCCH sub-frame may not have fixed lengths. Specifically, the lengths of the three parts may be affected by the speed of the multipath searcher and the accelerated rake.

If the device has more than one antenna, it may use some relevant HS-SCCH sub-frames to do antenna selection. For example, the device may perform antenna selection every other M relevant HS-SCCH sub-frames, where M is a positive integer.

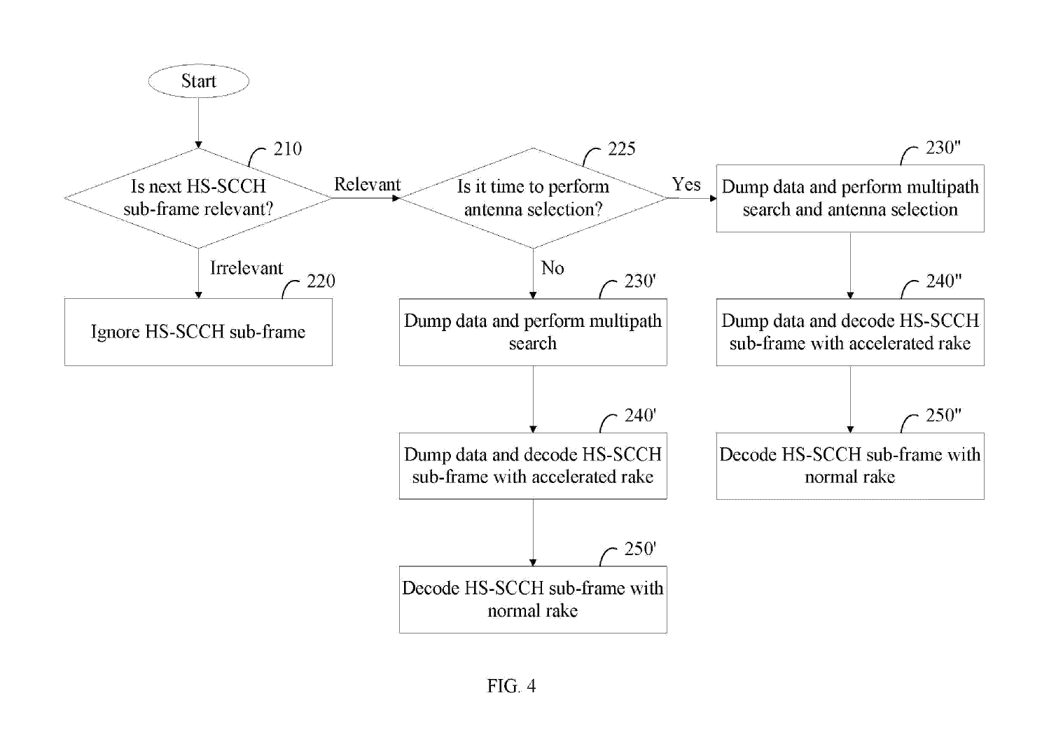

FIG. 4 shows a simplified flowchart of a method performed by a mobile communication device in the DRX mode. This device has a plurality of antennas, each of which may be connected to an RF circuit of the device. Because some of the steps in FIG. 4 are either the same as or very similar to some corresponding steps in FIG. 2, the following paragraphs will discuss only the differences between these two flowcharts.

The first difference is that if the oncoming HS-SCCH sub-frame is a relevant one, the device will leave step 210 and enter step 225. At step 225, the device determines whether it's time to perform antenna selection. If it's time to perform antenna selection, the device enters step 230″; otherwise, the device goes to step 230′. As mentioned above, the device may perform antenna selection every other M relevant HS-SCCH sub-frames.

Steps 230′, 240′, and 250′ are similar to steps 230, 240, and 250 discussed above, respectively, except for that at steps 230′, 240′, and 250′, a default or previously selected one of the antennas is used. Step 230″ is similar to step 230 discussed above, except for that at step 230″, the device further performs antenna selection simultaneously. For example, the selected antenna may be one that has a better receive quality. As another example, the result of multipath searchers may be used as a basis of antenna selection. Steps 240″ and 250″ are similar to steps 240 and 250 discussed above, respectively, except for that at steps 240″ and 250″, a newly selected antenna is used.

After step 250′ or 250″, if the device is instructed by the relevant HS-SCCH sub-frame to keep awake, it may use more than one antenna to receive subsequent HS-SCCH sub-frames and HS-DSCH sub-frames.

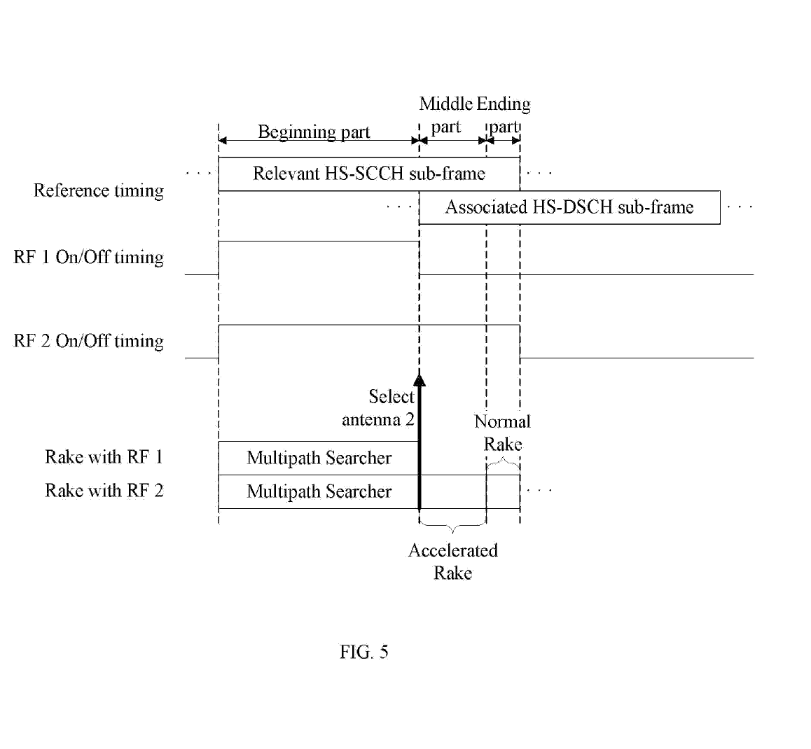

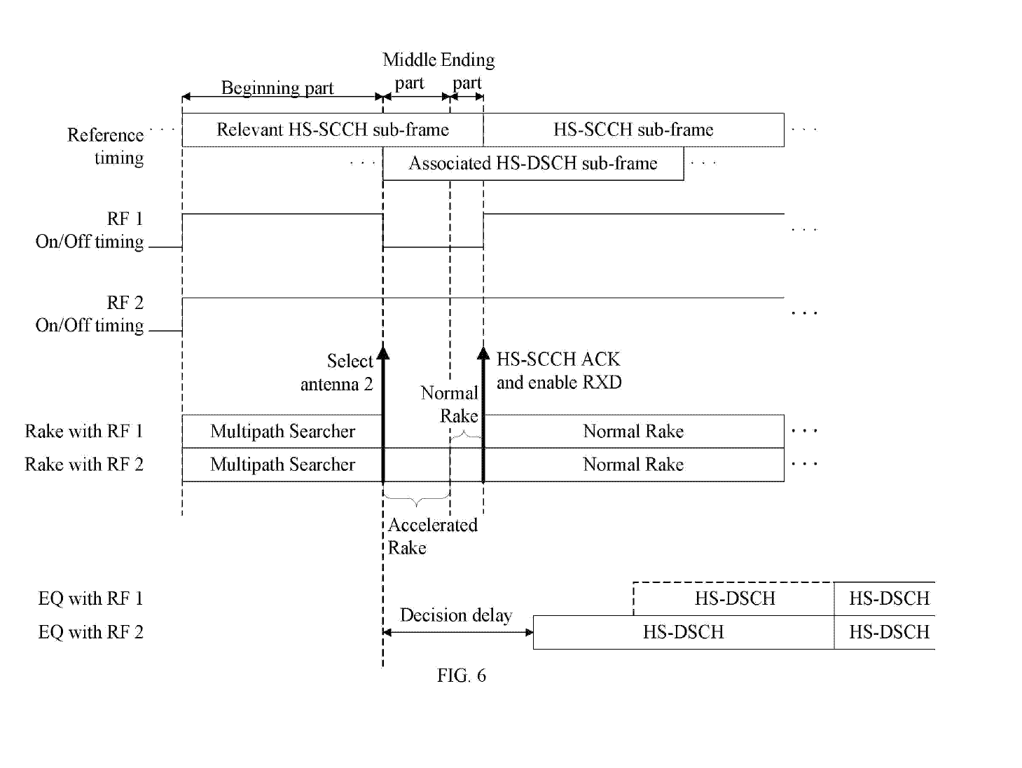

FIG. 5 shows a simplified timing diagram illustrating the device's operations in dealing with a relevant HS-SCCH sub-frame in the DRX mode. In this example, it's assumed that the device has two antennas (antenna 1 and antenna 2) and two of RF circuits (RF 1 that's connected to antenna 1 and RF 2 that's connected to antenna 2) and it's time for the device to perform antenna selection. Furthermore, it's assumed that antenna 2 is selected and the relevant HS-SCCH sub-frame does not instruct the device to keep awake.

FIG. 6 shows a simplified timing diagram illustrating the device's operations in dealing with a relevant HS-SCCH sub-frame in the DRX mode. In this example, it's assumed that the device has two antennas (antenna 1 and antenna 2) and two of RF circuits (RF 1 that's connected to antenna 1 and RF 2 that's connected to antenna 2), and it's time for the device to perform antenna selection. Furthermore, it's assumed that antenna 2 is selected initially and the relevant HS-SCCH sub-frame does instruct the device to keep awake. As this figure indicates, both antennas are used after the device replies an ACK message. Therefore, the device will be able to have receive-diversity (RXD) by combining the diversity of the two antennas. The device may use the normal rake to decode the subsequent HS-SCCH sub-frames at no or short decision delay, and use the EQ to decode the subsequent HS-DSCH sub-frames at a relatively longer (e.g. several symbols long) decision delay. Before the device rests again, the device may perform antenna selection so that it may be able to use a better antenna when the next relevant HS-SCCH sub-frame comes.

Although in the example shown in FIG. 6, the device enables RXD immediately after the HS-SCCH ACK, i.e. in the middle of a HS-DSCH sub-frame. To save power, the device may wait until the next HS-DSCH sub-frame to enable RXD.

FIG. 7 shows a simplified timing diagram illustrating the device's operations in dealing with a relevant HS-SCCH sub-frame in the DRX mode. The example shown in FIG. 7 is different from the previous example only in that in FIG. 7, a default or previously selected antenna is used in the beginning. In other words, the device does not use the beginning part of the relevant HS-SCCH frame to perform antenna selection. The default/previously-selected antenna is antenna 2 in FIG. 7. Although in the example shown in FIG. 7, the device enables RXD immediately after the HS-SCCH ACK, the device may save power by waiting until the next HS-DSCH sub-frame to enable RXD. Before the device rests, the device may perform antenna selection so that it may be able to use a better antenna when the next relevant HS-SCCH sub-frame comes.

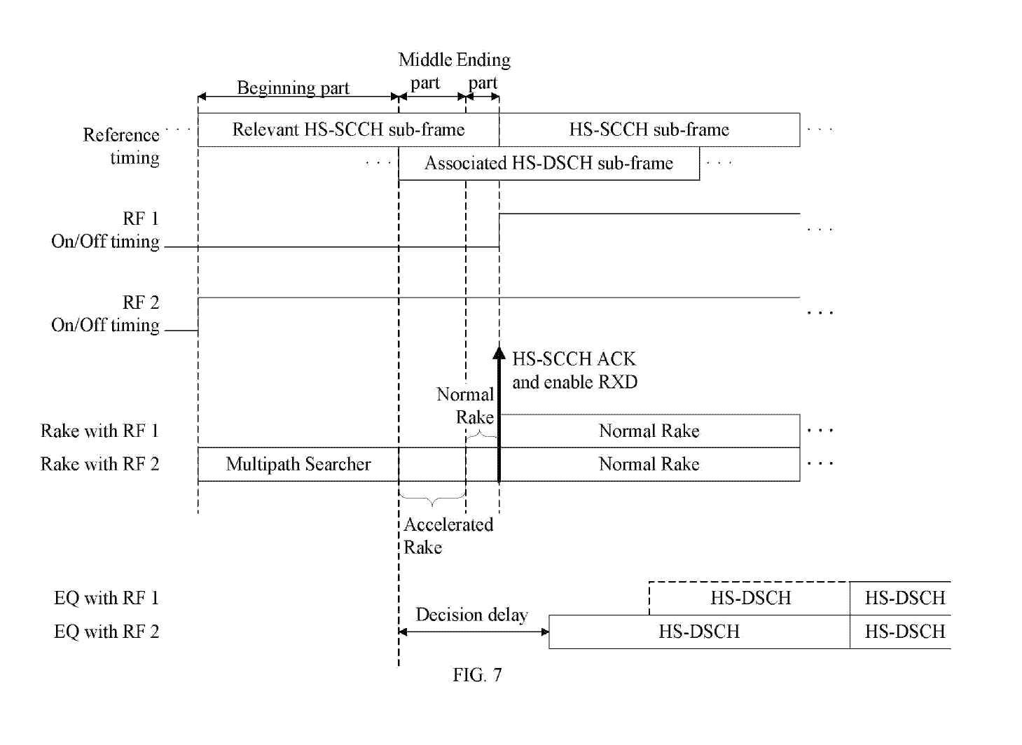

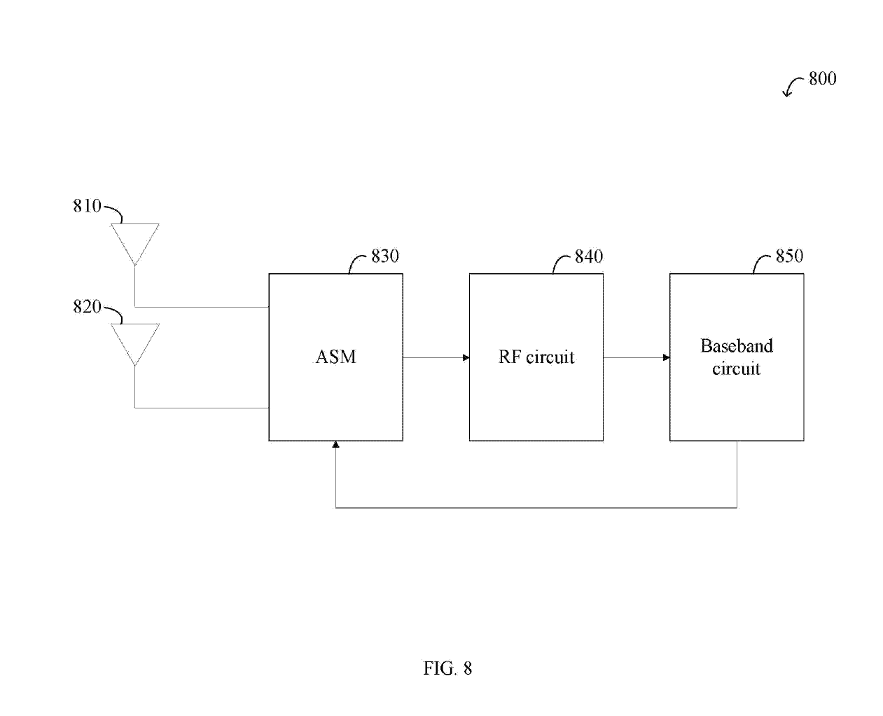

FIG. 8 shows a simplified block diagram of a mobile communication device according to an embodiment of the invention. This device 800 has a first antenna 810, a second antenna 820, an antenna switch module (ASM) 830, an RF circuit 840, and a baseband circuit 850; other components of the device 800 are omitted from the figure for the sake of simplicity. The ASM 830 may couple either the first antenna 810 or the second antenna 820 to the RF circuit 840. The RF circuit 840 down-converts the RF signals provided by the ASM 830 into baseband signals, which will then be processed by the baseband circuit 850. The baseband circuit 850 is further responsible for switching the ASM 830.

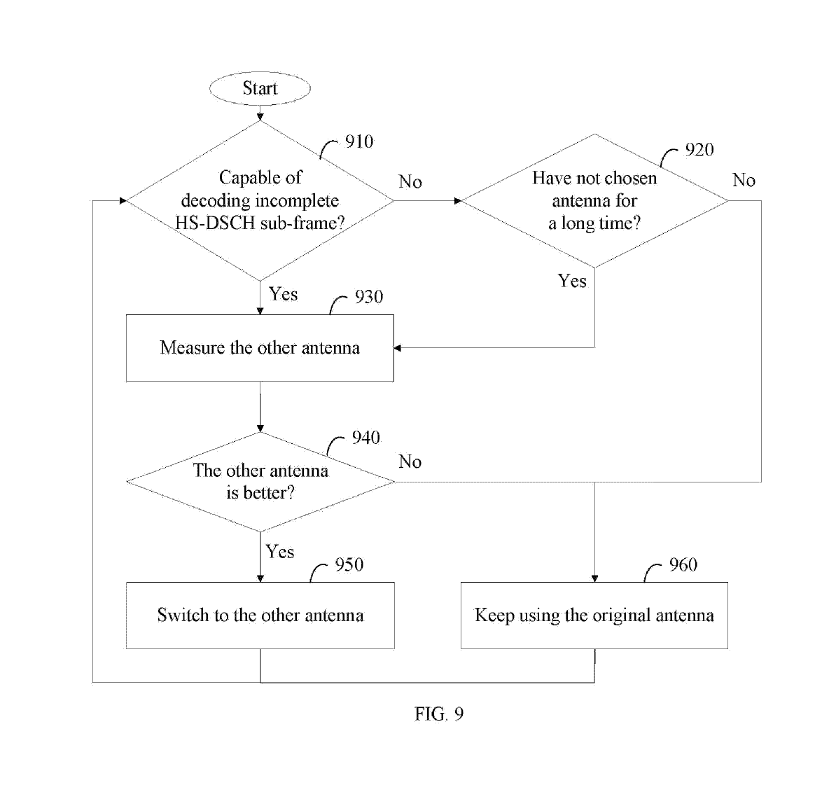

FIG. 9 shows a simplified flowchart of a method the device 800 performs. When performing this method, the device 800 is in a continuous reception mode. In the continuous reception mode, the device 800 has to receive and decode HS-SCCH and HS-DSCH sub-frames successively. For example, the device 800 may be said to be in the continuous reception mode when it's not in the DRX mode or it's in the DRX mode and has been instructed to keep awake. An advantage of this method is that it may allow to the device 800 to switch antenna frequently to ensure better reception.

At step 910, the device 800 determines whether it may decode a HS-DSCH sub-frame even if it does not receive the HS-DSCH sub-frame completely. If the answer is yes, the device 800 enters step 930; otherwise, it enters step 920. For example, step 910 may be performed when the device 800 has finished decoding an HS-SCCH sub-frame associated with the HS-DSCH sub-frame. If the device 800 determines that even if it does not receive the HS-DSCH sub-frame completely, it may still decode the HS-DSCH sub-frame successfully (e.g. through error correction), it enters step 930. At step 910, the device 800 may also determine when step 930 should start.

At step 910, the device 800 may compare a current quality curr_Q with a required quality req_Q plus a margin, wherein the margin may be a predetermined value. If curr_Q>req_Q+margin, the device 800 decides that it will not receive the HS-DSCH sub-frame completely and as a result enters step 930. For example, req_Q may be a function of the transport block size TB_size. Furthermore, curr_Q may a function of three factors. The first factor is harq_llr, which indicates the quality of a previously failed sub-frame. Specifically, “harq” stands for hybrid automatic repeat request, and “llr” stands for log-likelihood ratio. The second and third factors are a transport format resource indicator TFRI and a signal to interference ratio SIR.

At step 920, the device 800 determines whether it has not chosen antenna for a long time. If the answer is yes, the device 800 enters step 930; otherwise, it enters step 960. Step 920 allows device 800 to force antenna selection when it hasn't done so for a while. Specifically, if the device 800 leaves step 920 and enters step 930, it will perform antenna selection at the risk of sacrificing the reception of the current HS-DSCH sub-frame. This may cause the sacrificed HS-DSCH sub-frame to be re-transmitted.

At step 930, the device 800 uses a remaining part of the HS-DSCH sub-frame to measure the other antenna. This step may start after the device 800 has received a beginning part of the HS-DSCH sub-frame and the beginning part is sufficient to decode. In other words, step 930 may start when device 800 determines that the remaining part of the HS-DSCH sub-frame may be disregarded in the decoding process.

At step 940, the device 800 determines whether the other antenna measured at step 930 is better than the original antenna. If the answer is yes, the device 800 enters step 950 and switch to the other antenna. Otherwise, the device 800 enters step 960 and keeps using the original antenna. After step 950 or 960, the device 800 may return to step 910.

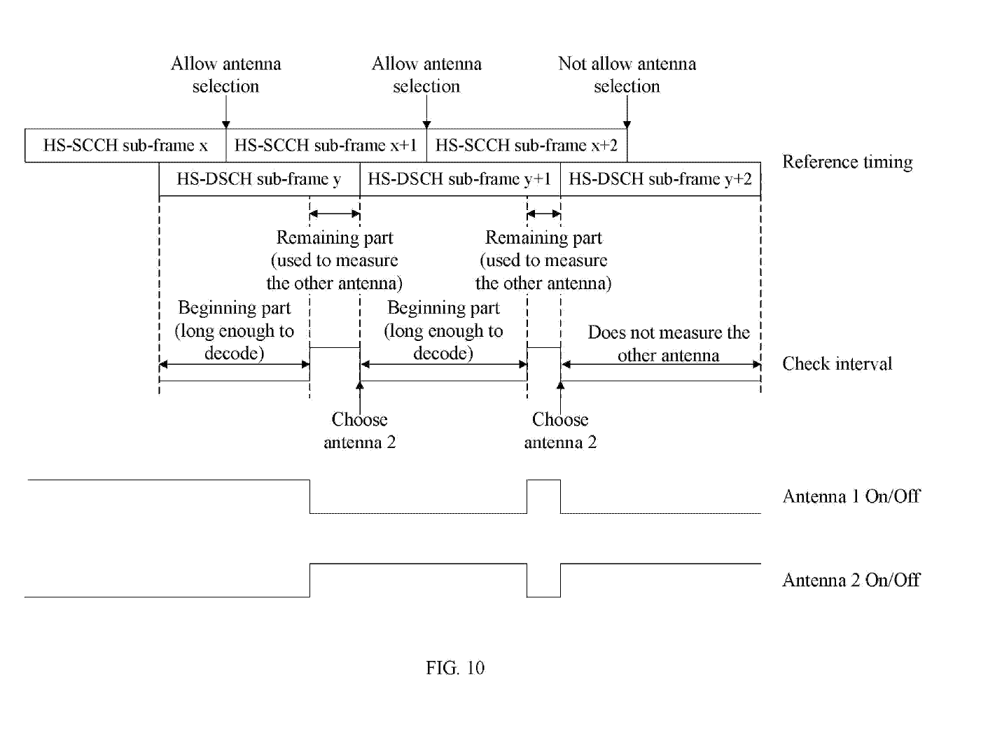

FIG. 10 shows a simplified timing diagram illustrating the device 800's operations in dealing with three pairs of HS-SCCH and HS-DSCH sub-frames in the continuous reception mode. At the end of HS-SCCH sub-frame x, the device 800 leaves step 910 and decides that it will use a remaining part of HS-DSCH sub-frame y to measure the other antenna (i.e. antenna 2) at step 930. At the end of HS-DSCH sub-frame y, the device 800 leaves step 940 and choses to use the other antenna (i.e. antenna 2). At the end of HS-SCCH sub-frame x+1, the device 800 leaves step 910. At the end of step 910 or shortly afterwards, the device 800 may decide whether to use a remaining part of HS-DSCH sub-frame y+1 or a beginning part of HS-DSCH sub-frame y+2 to measure the other antenna (i.e. antenna 1) at step 930. At the end of HS-DSCH sub-frame y+1 or shortly afterwards, the device 800 leaves step 940 and choses to use the original antenna (i.e. antenna 2). At the end of HS-SCCH sub-frame x+2 or shortly afterwards, the device 800 leaves step 910 and then 920 and decides that it will not measure the other antenna but will use the original antenna (i.e. antenna 2) to receive HS-DSCH sub-frame y+2 completely.

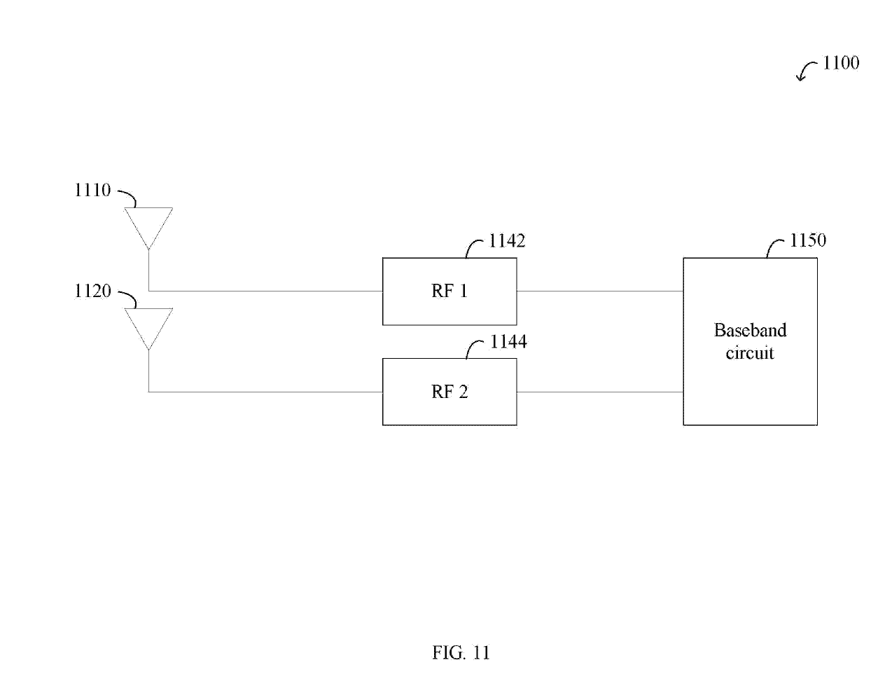

FIG. 11 shows a simplified block diagram of a mobile communication device according to an embodiment of the invention. This device 1100 has a first antenna 1110, a second antenna 1120, a first RF circuit (RF 1) 1142, a second RF circuit (RF 2) 1144, and a baseband circuit 1150; other components are omitted from the figure for the sake of simplicity. The first RF circuit 1142 down-converts the RF signals provided by the first antenna 1110 into baseband signals, which will then be processed by the baseband circuit 1150. The second RF circuit 1144 down-converts the RF signals provided by the second antenna 1120 into baseband signals, which will then be processed by the baseband circuit 1150. The device 1100 may select RF 1, RF 2, or both. If both RF 1 and RF 2 are selected, it may be said that the device 1100 is enabling receive-diversity (RXD).

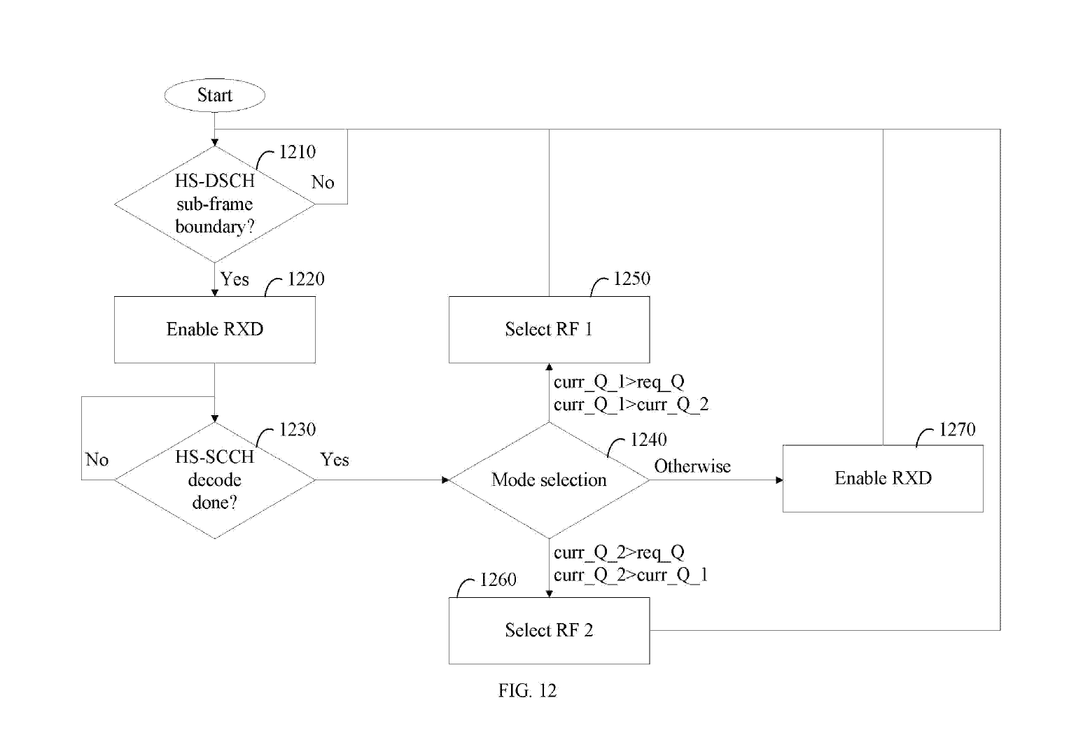

FIG. 12 shows a simplified flowchart of a method the device 1100 performs. When performing this method, the device 1100 is in a continuous reception mode. In the continuous reception mode, the device 1100 has to receive and decode HS-SCCH and HS-DSCH sub-frames successively. For example, the device 1100 may be said to be in the continuous reception mode when it's not in the DRX mode or it's in the DRX mode and has been instructed to keep awake. An advantage of this method is that it may allow to the device 1100 to save power without sacrificing much of its reception quality.

At step 1210, the device 1100 determines whether it has received a beginning boundary of a HS-DSCH sub-frame. If the answer is yes, the device 1100 enters step 1220; otherwise, it returns to step 1210. At step 1220, the device 1100 enables RXD. Specifically, the device 1100 uses antennas 1110 and 1120 and RF circuits 1142 and 1144 to receive RF signals. Then, at step 1230, the device 1100 determines whether it has decoded a HS-SCCH sub-frame. If the answer is yes, the device 1100 enters step 1240; otherwise, it returns to step 1230. Steps 1210, 1220, and 1230 allows the device 1100 to enable RXD during the period in which an ending part of a HS-SCCH sub-frame overlaps with a beginning part of an associated HS-DSCH sub-frame.

At step 1240, the device 1100 performs mode selection based on some parameters. For example, the parameters may include a required quality req_Q, a current quality curr_Q_{—}1, and a current quality curr_Q_{—}2. An exemplary definition of req_Q can be found above. The definitions of curr_Q_{—}1 and curr_Q_{—}2 are similar to the definition of curr_Q discussed above, except for that curr_Q_{—}1 is related to the first antenna 1110 and the first RF circuit 1142, while curr_Q_{—}2 is related to the second antenna 1120 and the second RF circuit 1144.

For example, if curr_Q_{—}1>req_Q and curr_Q_{—}1>curr_Q_{—}2, RF 1 is superior to RF 2 and RF 1 is sufficient to receive the remaining part of the HS-DSCH sub-frame. In response, the device 1100 may leave step 1240 and enter step 1250. If curr_Q_{—}2>req_Q and curr_Q_{—}2>curr_Q_{—}1, RF 2 is superior to RF 1 and RF 2 is sufficient to receive the remaining part of the HS-DSCH sub-frame. In response, the device 1100 may leave step 1240 and enter step 1260. Otherwise, the superior one of RF 1 and RF 2 alone may not be sufficient to receive the remaining part of the HS-DSCH sub-frame. In response, the device 1100 may leave step 1240 and enter step 1270. At step 1250, the device 1100 select RF 1 only. At step 1260, the device 1100 select RF 2 only. When the device 1100 enters either of these two steps, it may reduce its power consumption because only one of the RF circuits is used. At step 1270, the device 1100 keeps enabling RXD. Although step 1270 may cause the device 1100 to consume more power, the step may ensure that the device 1100 receives RF signal more correctly.

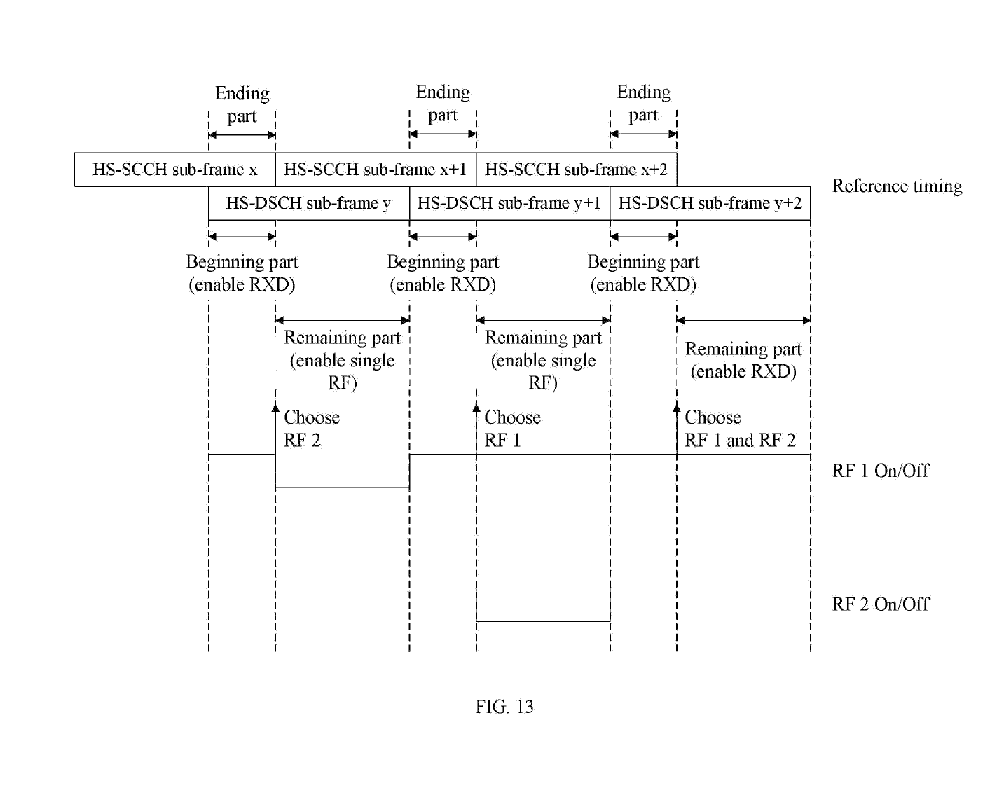

FIG. 13 shows a simplified timing diagram illustrating the device 1100's operations in dealing with three pairs of HS-SCCH and HS-DSCH sub-frames in the continuous reception mode. During the period when the ending part of HS-SCCH sub-frame x overlaps with the beginning part of the HS-DSCH sub-frame y, the device 1100 enables RXD. Afterward, the device 1100 selects RF 2 because curr_Q_{—}2>req_Q and curr_Q_{—}2>curr_Q_{—}1. During the period when the ending part of HS-SCCH sub-frame x+1 overlaps with the beginning part of the HS-DSCH sub-frame y+1, the device 1100 enables RXD. Afterward, the device 1100 selects RF 1 because curr_Q_{—}1>req_Q and curr_Q_{—}1>curr_Q_{—}2. During the period when the ending part of HS-SCCH sub-frame x+2 overlaps with the beginning part of the HS-DSCH sub-frame y+2, the device 1100 enables RXD. Afterward, the device 1100 selects both RF 1 and RF 2 because curr_Q_{—}1<req_Q and curr_Q_{—}2<req_Q.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A method performed by a mobile communication device in a discontinuous reception (DRX) mode, comprising:
dumping contemporarily received data and performing multipath search while a beginning part of a relevant sub-frame in a control channel is being transmitted;
dumping contemporarily received data and decoding dumped data with an accelerated rake while a middle part of the relevant sub-frame is being transmitted; and
decoding contemporarily received data with a normal rake while an ending part of the relevant sub-frame is being transmitted.

2. The method of claim 1, wherein the method further comprises:
enabling a single antenna of the device while the middle and the ending parts of the relevant sub-frame are being transmitted.

3. The method of claim 1, wherein the method further comprises:
performing antenna selection while the beginning part of the relevant sub-frame is being transmitted.

4. The method of claim 1, wherein the method further comprises:
enabling a plurality of antennas of the device if the relevant sub-frame instructs the device to keep awake.

5. The method of claim 4, wherein the method further comprises:
performing antenna selection before resting.

6. The method of claim 1, wherein the control channel is a high speed shared control channel (HS-SCCH).

7. A method performed by a mobile communication device in a continuous reception mode, comprising:
determining whether a beginning part of a sub-frame on a data channel received by a first antenna of the device is sufficient to decode;
measuring a second antenna of the device while a remaining part of the sub-frame is being transmitted if the beginning part of the sub-frame received by the first antenna is sufficient to decode; and
choosing one from the first and second antennas and then using the chosen antenna to receive at least a beginning part of a next sub-frame on the data channel.

8. The method of claim 7, wherein the step of determining whether the beginning part of the sub-frame received by the first antenna is sufficient to decode comprises:
comparing a current reception quality with a required reception quality plus a margin.

9. The method of claim 8, wherein the required reception quality if a function of a transport block size.

10. The method of claim 8, wherein the current reception quality if a function of a hybrid automatic repeat request log-likelihood ratio (harq-llr), a transport format and resource indicator (TFRI), and a signal to interference ratio (SIR).

11. The method of claim 7, wherein the data channel is a high speed downlink shared channel (HS-DSCH).

12. A method performed by a mobile communication device in a continuous reception mode, comprising:
enabling a first and a second antenna when a beginning part of a sub-frame in a data channel is being transmitted; and
disabling an inferior one of the first and second antennas while a remaining part of the sub-frame is being transmitted if a superior one of the first and second antennas is sufficient to receive the remaining part of the sub-frame.

13. The method of claim 12, wherein the superior one of the first and second antennas is sufficient to receive the remaining part of the sub-frame if a current reception quality associated with the superior one of the first and second antennas is larger than a required reception quality.

14. The method of claim 13, wherein the required reception quality if a function of a transport block size.

15. The method of claim 13, wherein the current reception quality if a function of a hybrid automatic repeat request log-likelihood ratio (harq-llr), a transport format and resource indicator (TFRI), and a signal to interference ratio (SIR) associated with the superior one of the first and second antennas.

16. The method of claim 12, wherein the data channel is a high speed downlink shared channel (HS-DSCH).
